(19) United States
(12) Patent Application Publication
(10) Pub. No.: US 2009/0078357 A1
(43) Pub. Date: Mar. 26, 2009

(54) METHOD FOR MONITORING FOR CRACKING IN A COMPONANT

(75) Inventor: Nigel Laxton, Mt. Hawthorn (AU)

Correspondence Address: DAVIS WRIGHT TREMAINE, LLP/Seattle, 1201 Third Avenue, Suite 2200, SEATTLE, WA, 98101-3045, US

(73) Assignee: STRUCTURAL MONITORING SYSTEMS LTD, Osborne Park (AU)

(21) Appl. No.: 12/282,871

(22) PCT Filed: Mar. 16, 2007
(86) PCT No.: PCT/AU2007/000334

§ 371 Date: Oct. 30, 2008

(30) Foreign Application Priority Data
Mar. 16, 2006 (AU) 2006901363

(51) Int. Cl. B32B 38/00

(52) U.S. Cl. 156/64

(57) ABSTRACT

A method of monitoring cracking in a component comprises forming a component with a simultaneously formed elongate hole that is internal to the component. A connector having a throughway is attached to the component such that the throughway is in fluid communication with the elongate hole. The elongate hole is connected to a pressure measurement instrument via the connector. A monitoring system then monitors the elongate hole for a change in pressure level.

### FIELD OF THE INVENTION

The present invention relates to a method for monitoring for cracking of a component and to a connector for use in monitoring for cracking of a component.

### BACKGROUND

Cracking and flaws within a stressed component can result in impeded performance of the component and, in the worst case scenario, catastrophic failure. Consequently, monitoring for the presence of such cracks and flaws is often a requirement. Cracking may occur solely within the component, or may be a surface crack that penetrates into the component.

In some situations cracking can be tolerated up to a maximum length of crack. In such situations it may be desirable to be able to not only monitor for the presence of a crack, but also determine the crack length at any particular time and further observe the growth of a crack over time.

Ideally, some components are tested in situ, rather than the component being taken off line, which may involve disassembly of a larger structure.

### SUMMARY OF THE INVENTION

According to a first aspect of the present invention, there is provided a method of monitoring for cracking of a component, the method comprising:
forming a component with an elongate hole that is internal to the component;
attaching a connector having a throughway to the component, such that the throughway is in fluid communication with the elongate hole;
connecting the elongate hole to a pressure measurement instrument via the connector; and
monitoring the elongate hole for change in pressure level.

According to a second aspect of the present invention, there is provided a method of monitoring for cracking of a component, the method comprising:
providing a raw material;
forming a component from the raw material and simultaneously introducing an elongate hole into the component that is internal to the component;
attaching a connector having a throughway to the component, such that the throughway is in fluid communication with the elongate hole;
connecting the elongate hole to a pressure measurement instrument via the connector; and
monitoring the elongate hole for change in pressure level.

Thus, the elongate hole within the component is formed in the initial forming step of the component.

In one embodiment, the forming step involves extruding the component and simultaneously extruding the elongate hole.

In an alternative embodiment, the forming step involves inserting a core into a casting mould, casting the component and subsequently removing or burning out the core to form the elongate hole.

In a further alternative embodiment, in which the component is a laminate of a plurality of layers, and the forming step involves providing a elongate hole shape within the laminate during the lamination process.

In such an embodiment, the elongate hole shape can be provided by inserting a hole form between the two adjacent layers during the lamination process. The hole form can be a tube. Alternatively, the hole form can be a mandrel that is removed subsequent to the lamination process.

In one embodiment, the component is formed such that the elongate hole has an opening at a first surface of the component and the connector is attached to the elongate hole at the opening.

The connector may comprise a flange portion that is attached to the component adjacent the elongate hole and a tube portion extending from the flange portion, and wherein the throughway extends through the tube portion and the flange portion.

Alternatively, the connector may comprise a substantially rigid tube that is partially inserted into the elongate hole. The tube can be attached to the elongate hole by an adhesive. Alternatively or additionally, the tube can be attached to the elongate hole by an interference fit. The tube may be provided with a barb or barb-like member on an outer surface of the tube.

In an alternative embodiment, the component has an internal thread provided within a portion of the elongate hole that is adjacent the opening, and the connector comprises an externally threaded portion that is received within the elongate hole and a tube portion extending from the threaded portion, the throughway extending through both the tube portion and the threaded portion.

The connector can further comprise a body portion disposed between the tube portion and threaded portion, the body portion having a larger outer diameter than both the tube portion and threaded portion.

In one embodiment of the method, the elongate hole is one of a plurality of like elongate holes, each elongate hole being connected to one of the pressure measurement instrument and another of the like elongate holes.

In yet a further embodiment the method comprises forming a plurality of the elongate holes, connecting one or more but not all of said elongate holes to the pressure measurement system thereby leaving one or more unconnected elongate holes and in the event of a connected elongate hole becoming inoperable, disconnecting or damaged, isolating that hole and connecting at least one of the unconnected holes to the pressure measurement system.

The component may be formed such that the elongate hole has an opening at a second surface of the component, the method further comprising the step of sealing the elongate hole at or in a region adjacent the opening at the second surface.

The sealing step may comprise applying a sealant to fill a portion of the elongate hole adjacent the opening at the second surface.

Alternatively, the sealing step may comprise forming a secondary hole that extends transversely to the elongate hole such that the elongate hole and the secondary hole intercept, and inserting a plug into the secondary hole such that the elongate hole is sealed.

The plug may comprise a compressible bung portion that can be compressed within the secondary hole to seal the elongate hole.

A portion of the secondary hole can be provided with an internal thread, and the plug may further comprise an externally threaded element that can provide compression to the bung portion when the plug is in the secondary hole.

In one embodiment of the method, in which the component further comprises a secondary hole that extends transversely to the elongate hole such that the elongate hole and the secondary hole intercept, the attaching step can involve inserting the connector into the secondary hole.

The connector can comprise a pin portion through which the throughway extends, and the attaching step further involves inserting the pin portion into the secondary hole.

The connector may further comprise a head portion from which the pin portion extends, the head portion having an opening in fluid communication with the throughway, and wherein the connecting step involves inserting tubing into the opening.

The throughway in the connector may be one of a pair of like throughways in the connector, and the pin portion further comprises a partition for dividing the elongate hole into a first elongate hole and a second elongate hole.

The partition can provides a seal such that the first elongate hole is substantially in fluid isolation from the second elongate hole.

The method may further comprise the step of aligning the pin portion within the secondary hole such that each of the throughways is in fluid communication with a respective one of the first or second elongate holes.

According to a third aspect of the present invention, there is provided a connector for use in a pressure monitoring system that is applied to a component having an elongate hole that extends through the component adjacent to a surface of the component and a secondary hole that extends from the surface and intercepts the elongate hole, the connector comprising:
a pin portion that is receivable in the secondary hole, the pin portion defining a partition for dividing the elongate hole into a first elongate hole and a second elongate hole;
a first throughway that extends through the connector and opens onto a first side of the partition and a second throughway that extends through the connector and opens onto a second opposing side of the partition.

In one embodiment, the pin portion further comprises a seal such that, in use, the first elongate hole is substantially in fluid isolation from the second elongate hole.

The connector can further comprise a head portion from which the pin portion extends, wherein each throughway opens onto an external surface of the head portion.

Each opening on the external surface of the head portion can be shaped to receive tubing for connecting the connector into the pressure monitoring system.

In one form of the connector, the pin portion is shaped to establish an interference fit when inserted into the secondary hole.

According to a fourth aspect of the present invention, there is provided a pressure monitoring system comprising:
a component to be monitored having a sealed elongate hole that extends substantially through the component adjacent to a surface of the component and a secondary hole that extends from the surface and intercepts the elongate hole, and
a connector having a pin portion that is receivable in the secondary hole, the pin portion having a partition that divides the elongate hole into a first elongate hole and a second elongate hole; a first throughway that extends through the connector and opens onto a first side of the partition; and a second throughway that extends through the connector and opens onto a second opposing side of the partition.

The system can measure the pressure level within the elongate hole as a pressure differential relative to a reference pressure.

### BRIEF DESCRIPTION OF THE DRAWINGS

In order that the invention may be more easily understood embodiments will now be described, by way of example only, with reference to the accompanying drawings, in which:

FIG. 1: is an axiomatic view of a component and a connector according to a first embodiment of the present invention;

FIG. 2: is an axiomatic view of a component and a connector according to a second embodiment of the present invention;

FIG. 3: is an axiomatic view of a component and a connector according to a third embodiment of the present invention;

FIG. 4: is a cross section view of a component and a connector according to a fourth embodiment of the present invention;

FIG. 5: is an axiomatic view of the component and connector of FIG. 4;

FIG. 6: is a schematic axiomatic view of a connector according to a fifth embodiment of the present invention; and

FIG. 7: is a cross section view of a plug according to a sixth embodiment of the present invention.

### DETAILED DESCRIPTION OF THE PREFERRED EMBODIMENTS

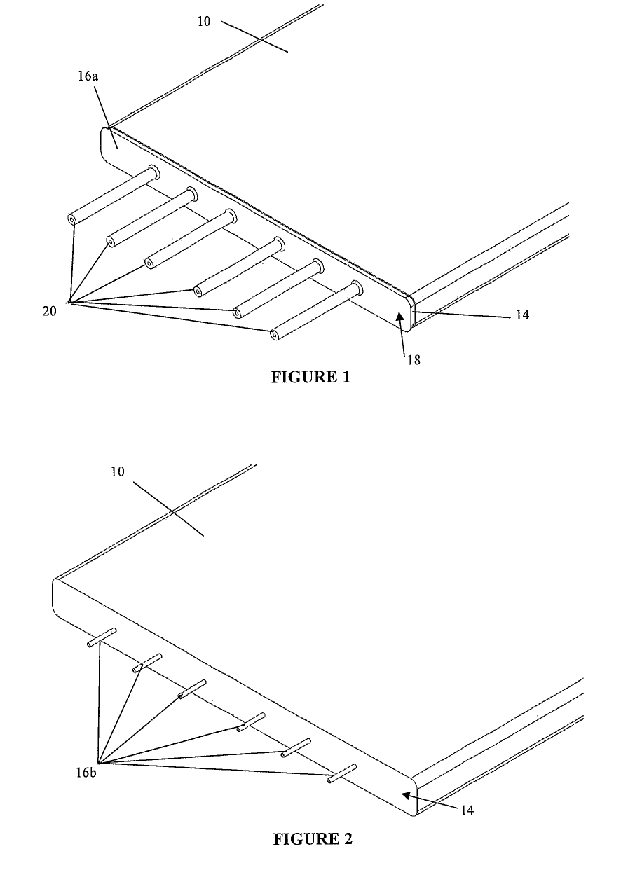

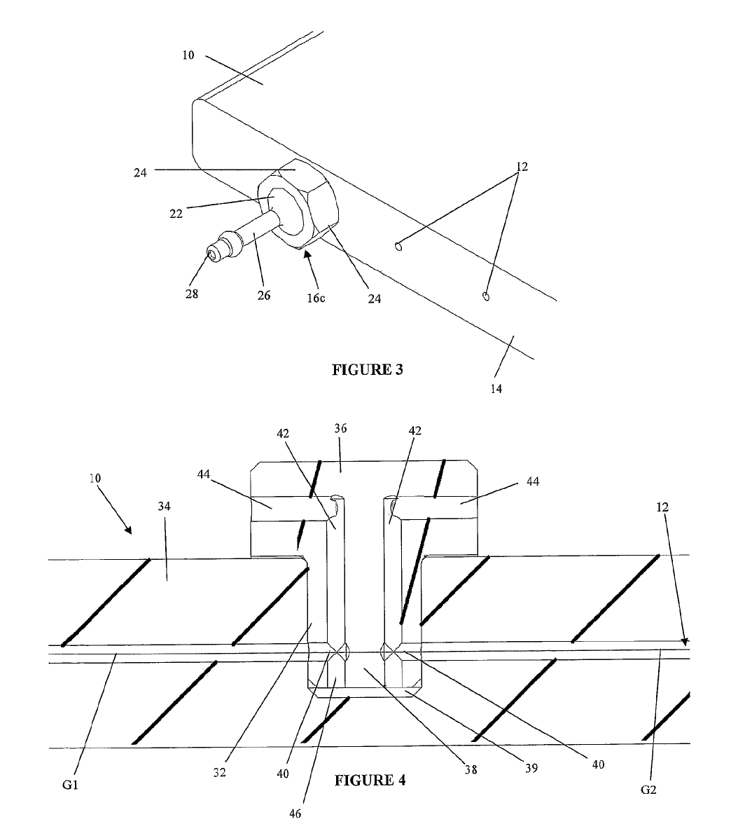

FIGS. 1 to 5 and 7 show a component 10 that is elongate and has a constant cross section. Elongate holes 12 (as shown in FIGS. 3, 4 and 7) extend through the component 10 in the elongate direction. Each elongate hole 12 opens onto the end faces 14 of the component. The elongate holes 12 form galleries of a pressure monitoring system. The monitoring system may comprise a system for measuring pressure differentials between the holes 12 and an ambient pressure. The system may typically include a pressure source and a pressure or differential pressure measurement instrument. The pressure source is applied to the holes 12 and can be at a positive pressure relative to ambient pressure or at a negative pressure relative to ambient pressure (i.e. a relative vacuum). One example of a relative negative pressure (i.e. vacuum) based monitoring system is discussed in U.S. Pat. No. 5,770,794, the contents of which is incorporated herein by way of reference. An example of a relative positive pressure based monitoring system is described in International Publication No. WO 02/21096. The monitoring system, whether it be based on a relative positive

pressure or relative negative pressure will provide a measure or indication of pressure change in pressure in the holes, or alternately pressure differential or a change in pressure differential between the holes 12 and ambient pressure.

A crack that intersects one of the elongate holes 12 in the component can be detected by a change in the pressure level(s) in the respective elongate holes 12 that are measured by the instrument of the monitoring system. It is to be appreciated that the spacing of elongate holes 12 will have a direct influence of the minimum detectable crack length. The component 10 shown in the figures may be, for example, an aluminium stringer used in the structure of an aircraft.

In some embodiments while multiple elongate holes are provided, such as shown in FIG. 1, not all of the holes 12 need be connected at the same time to the monitoring system. Some of the holes 12 may be provided as redundant holes to be used or connected to the monitoring system when a previously connected hole 12 becomes blocked, damaged or otherwise inoperable. In such an embodiment a switching system may be incorporated to open and close valves between the holes and the monitoring system (for example in connectors 16) which are operated to isolate a hole 12 that becomes blocked, damaged or otherwise inoperable and connect a previously unused or isolate “healthy” hole 12 to the monitoring system.

The elongate holes 12 are formed in the component 10 during the manufacturing process of the component 10. In this embodiment, the component 10 has a constant cross section, and the size and relative position of the elongate holes 12 is also constant. The elongate holes 12 have an internal diameter of less than 5 mm. Typically, the elongate holes 12 have an internal diameter of approximately 0.5 mm. It is to be appreciated that the component 10 can be formed by an extrusion process, such that the elongate holes 12 are formed in the component 10 simultaneously with the forming of the component.

As shown in FIGS. 1 to 3, a connector 16a, 16b, 16c (hereinafter referred to in general as “connectors 16”) can be used to connect to tubing (not shown) for plumbing the monitoring instrument. As previously noted, the elongate holes 12 in the component 10 shown in FIGS. 1 to 5 and 7 open onto an end face 14 of the component 10.

The connector 16a shown in FIG. 1 is in the form of flanged portion 18 that is affixed to an end face 14, for example by a pressure sensitive adhesive. Tubes 20 extend from the flanged portion 18, each tube 20 registering with an opening of one of the elongate holes 12 at the respective end face 14. Each tube 20 defines a throughway that extends through the respective tube 20 and the flanged portion 18. Affixing of the flanged portion 18 to the end face 14 and about the openings of the elongate holes 12 facilitates the forming of a substantially hermetic seal about the opening of each of the elongate holes 12. Accordingly, flow of atmospheric air between the flanged portion and end face, and thus into the elongate holes 12, is minimized.

The connectors 16b shown in FIG. 2 are each in the form of a substantially rigid tube of, for example, a metal, metal alloy or plastics material. The outer diameter of the connectors 16b is substantially equal to the inner diameter of the elongate holes 12. Each connector 16b can be press-fitted or otherwise affixed (for example, by an adhesive) into a respective one of the elongate holes 12. In embodiments of the connector 16b that are press-fitted into the elongate holes 12, the interference between the connector 16b and the component 10 about the respective hole forms a seal. To facilitate insertion and the formation of a suitable seal, the connector 16b can have a conical outer surface that tapers toward the end of the connector 16b that is inserted into the elongate hole 12.

The connectors 16b shown in FIG. 2 are in the form of linear tubes with smooth outer surfaces. It will be appreciated that alternative embodiments may be provided in which one or more bends are provided along the length of the connector 16b. The connectors 16b may be provided with barbs on the outer surface to facilitate the connection with tubing (not shown) to plumb to other elements within the monitoring system.

The connector 16c shown in FIG. 3 has an externally threaded element (not shown in FIG. 3) that engages an internal thread (also not shown) adjacent the opening of the respective elongate hole 12. The externally threaded element extends from a body portion 22. As shown in FIG. 3, the body portion 22 can be provided with flats 24 to facilitate rotation of the connector 16c such that the connector 16c engages the internal thread adjacent the opening. A pin portion, such as a spigot 26, extends from the body portion 22 in the opposite direction to the externally threaded element. A throughway 28 is provided that extends through the spigot 26, the body portion 22 and the externally threaded element. Thus, when the connector 16c is fastened to a component 10 the throughway 28 registers with the respective elongate hole 12. The body portion 22 has a larger outer diameter than the spigot 26 and threaded element.

It will be appreciated that in order to effect monitoring of the pressure level in an elongate hole 12, or a change in pressure differential between a hole 12 and ambient pressure, and thus monitor for the presence of a crack that intersects the respective elongate hole 12, it is desirable that the elongate hole 12 is substantially hermetically sealed. In some instances it may be desirable to seal a elongate hole 12 at, or near, an end face 14. This can be done by simply sealing the respective elongate hole 12 at the opening onto the end face 14 using any suitable sealant, such as, for example, polyurethane or silicone. Alternatively, sealing of an elongate hole 12 may be achieved by filling a portion of the elongate hole 12 adjacent the opening onto the end face 14 with a metal or metal alloy with a pin or plug that is inserted into the elongate hole 12. Such a pin can be oversize with respect to the hole such that the pin is press-fitted into the elongate hole 12. Alternatively or additionally, an adhesive/sealant may be used to retain the pin within the elongate hole 12 and form a seal between the component and the pin.

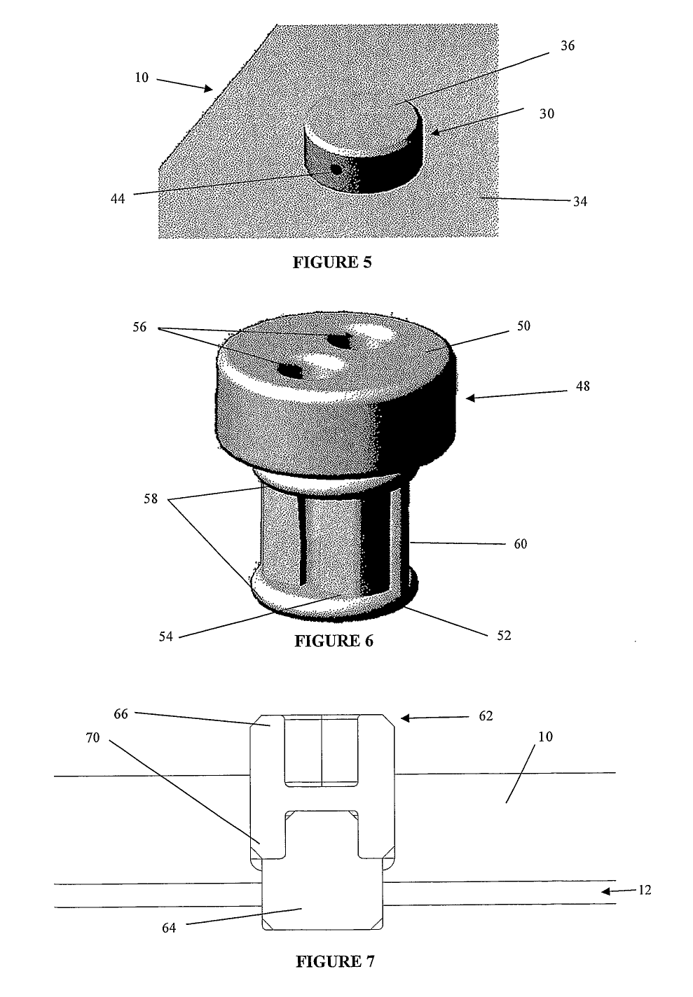

In some instances it may be impractical to provide a connector that registers with the respective elongate hole 12 by connection in the elongate direction of the elongate hole 12. FIGS. 4 and 5 show a connector 30 that is to be received within a secondary hole 32 formed in the component 10. The secondary hole 32 extends from a side surface 34 of the component 10 such that the secondary hole 32 is transverse to the elongate hole 12. As shown in FIG. 4, the elongate hole 12 and secondary hole 32 intercept. The connector 30 has a head portion 36 and a pin portion 38. The pin portion 38 is received within the secondary hole 32 such that there is an interference between the pin portion 38 and the component 10 about the secondary hole 32.

A first passageway 40 within the pin portion 38 registers with the elongate hole 12 and is also co-linear with the elongate hole 12. A second passageway 42 extends through the pin portion 38 from the tip 39 of the pin portion 38 into the head portion 38. The second passageway 42 is transverse to the first passageway 40, such that the first and second passageways 40, 42 intercept. A third passageway 44 extends from an edge of the head portion 36 into the head portion 36. The third passageway 44 is transverse to the second passageway 42, such that the second and third passageways 42, 44 intercept. The first, second and third passageways 40, 42, 44 together form a throughway of the connector 30.

Tubing (not shown) to plumb the connector 30 to other elements within the monitoring system can be received within the third passageway 44. Alternatively or additionally, a connector 16b such as that shown in FIG. 2 can be used to connect tubing to the third passageway 44. A small bung 46 or the like can be used to seal the end of the second passageway 42 that is adjacent the tip 39 of the pin portion.

As shown in FIG. 4, the connector 30 forms a partition in the elongate hole 12, such that the elongate hole 12 is divided into a first and second elongate hole G₁, G₂ that are in fluid isolation from one another. Furthermore, as also shown in FIG. 4, the connector 30 has two first passageways 40, two second passageways 42 and two third passageways 44 such that tubing can be plumbed to each of the first and second elongate holes G₁, G₂ via the connector 30.

The connector 30 in FIG. 4 is aligned such that the first passageways 40 (and thus the throughways) are each in fluid communication with a respective one of first and second elongate holes G₁, G₂.

It is to be appreciated that sealing between the pin portion 38 and the component 10 is of importance to the performance of the monitoring system. A sealant or similar adhesive may be used to establish a seal about the pin portion 38. However, it will be appreciated that the sealant/adhesive should be applied with care to ensure any of the elongate hole 12, first passageways 40, second passageways 42 and/or third passageways 44 are not blocked (either partially or completely).

Alternatively, a seal may be established between the pin portion 38 and the component 10 by an interference fit. It will be appreciated that to establish an appropriate interference fit the pin portion 38 should be oversize with respect to the secondary hole 32. Furthermore, the tolerance of the pin portion 38 dimensions and/or the secondary hole 32 dimensions may need to be tightly controlled. The pin portion 38 may be made of a material that has some “give”, such as a relatively hard elastomer or similar plastics material.

In some applications the connector 30 may tend to be dislodged from the component 10, such as by vibration of the component 10 or by impact from other objects. In such situations, it may be necessary to adhere the connector 30 to the component, such as by adhering the head portion 36 to the side surface 34.

FIG. 6 shows a connector 48 that is similar to the connector 30 in that, in use, the connector 48 is disposed within a secondary hole 32 that is transverse to, and intercepts, the elongate hole 12. The connector 48 has a head portion 50 and a pin portion 52, which is received within the secondary hole 32. The connector 48 has two faces 54 (one is shown in FIG. 6) that each are aligned to face in the direction of the elongate hole 12. Two throughways 56 extend from an opening 58 in the head portion 50 and through the head portion 50. Each throughway 56 opens onto a respective one of the two faces 54. Thus, each throughway 56 is in fluid communication with the elongate hole 12. Tubing to plumb the connector 48 to other elements within the monitoring system can be received within the throughways 56.

The connector 48 has two sealing rings 58 that are positioned at opposing ends of the pin portion 52. Each sealing ring 58 extends circumferentially around the pin portion 52. In addition, two sealing strips 60 (one is shown in FIG. 6) extend along the pin portion 52 to join the two sealing rings 58. Each sealing strip 60 is positioned between the two faces 54. Accordingly, when the connector 48 is inserted into an elongate hole 12, the connector 48 divides the elongate hole 12 into first and second elongate holes that are substantially in fluid isolation from one another.

The connector 48 can be moulded in a plastics material, such as a fluoropolymer. The connector 48 and secondary hole 32 can be dimensioned such that the sealing rings 58 and sealing strips 60 form an interference fit within the secondary hole 32. Accordingly, the sealing rings 58 and sealing strip 60 form a suitable seal to minimize the risk of leaks.

It is to be appreciated that the orientation of the third passageways 44 in the connector 30, and similarly the throughways 56 in the connector 48, may be selected to provide alternative take-off angles and directions for the tubing to that illustrated in the figures.

FIG. 7 shows plug 62 for blocking off a portion of a elongate hole 12 within a component 10. A secondary hole 70 that extends transverse to, and intercepts, the elongate hole 12 is provided in the component 10. In use, the plug 62 is disposed within the secondary hole 70. The plug 62 has a bung portion 64 and an externally threaded member, such as a grub screw 66. The secondary hole 70 has a complementary thread to engage with the external thread on the grub screw 66. The bung portion 64 can be made of an elastomeric material such that the bung portion 64 can be compressed to form a seal about the elongate hole 12 and secondary hole 70; thus blocking off and dividing the elongate hole 12. The bung portion 64 can be adhered to the grub screw 66 such that the bung portion 64 can be removed from the secondary hole 70 with the grub screw 66. Alternatively or additionally, the bung portion 64 can be provided with a lip (not shown) that is received within a corresponding groove (also not shown) in the grub screw 66 such that the bung portion 64 and grub screw 66 are connected.

The plug 62 may provide an alternative seal for an end of the elongate hole 12 to sealing the elongate hole 12 at the opening on to the end face 14. One advantage of the plug 62 over a seal at the end face is that the plug 62 may later be readily removed and replaced with a connector, such as, for example, either the connector 30 or connector 48.

It will be understood to persons skilled in the art of the invention that many modifications may be made without departing from the scope of the invention. For example, instead of forming a component having elongate holes in an extrusion process, the component, with the holes, may be formed in a component during other manufacturing processes. For example, holes may be formed:
(a) during casting of a metallic, plastic or ceramic component by placing cores in the mould (which are removed by, for example burning out the cores, after the initial pour) before the metal is poured. Contiguous elongate holes in the solidified component will be formed that can be used in a monitoring system. An example of such an component formed by casting the component with holes is an engine block;
(b) during casting of concrete structures by placing cores (that are also removed by, for example, burning out the cores), or fine tubes, in the moulds and subsequently pouring concrete around the cores to form the elongate holes for use in a monitoring system; and
(c) during the lay-up process of a laminate structure, which is fabricated from a plurality of layers which are sandwiched together and cured. Elongate holes within such a laminate structure may be formed by leaving gaps between plies, placing a hole form, such as tubes between the plies or alternatively mandrels during the lay-up process that are subsequently removed. Once the laminate structure has been cured these elongate holes can be used in a monitoring system. Such laminate structure, which may be a composite laminate, are used extensively in modern aircraft. The elongate holes may be provided within a single layer in the laminate. Alternatively or additionally, the elongate holes may extend from one layer to another adjacent layer. Furthermore, an elongate holes may be formed in a laminate by leaving spaces between adjacent layers of the laminate structure.

In some embodiments, the component may be formed with one or more blind elongate holes. Accordingly, a single opening is provided on a surface of the component. Similarly, the component may be formed such that the elongate hole(s) do not open onto the surface of the component after the component forming step; that is, the elongate holes may be completely internal to the component after forming of the component. Subsequently, one or more secondary holes may be drilled or otherwise created in the component that each intercept one of the elongate holes. Connectors will then be provided to plumb the elongate holes to instrumentation of the monitoring system or other elongate holes.

The elongate holes 12 are not limited to being of circular cross section. Indeed, any desired cross section may be employed. Further, the elongate holes 12 need not be of uniform cross section. For example, portions of an elongate hole 12 may form a bulbous portion or a waist portion with respect to other portions of the respective elongate hole 12. It will also be appreciated that an elongate hole 12 need not be linear and may have, for example, one or more arcuate portions of varying radii.

Elongate holes 12 in two or more components 10 may be interconnected to form an extended hole. The hole need not of course be straight and can include numerous bends and turns. For example, elongate holes in two or more stringers of an aircraft wing may be interconnected. Similarly, elongate holes in the skin of an aircraft made of a laminate structure may be interconnected with elongate holes in a nearby stringer. Moreover frames, longerons, spars and other aircraft extrusions may be joined together with respective elongate holes in fluid communication to form circuits or networks of holes that can be used to detect or monitor cracks. This opens the possibility of structural health monitoring where the integrity of a large structure can be monitored as distinct from individual components or parts of a structure.

In embodiments in which a plurality of elongate holes 12 are provided within the component 10, elongate holes 12 may be connected in parallel, in series (in which two or more elongate holes 12 connected together), or in sets of elongate holes that are in parallel to other sets. In embodiments in which elongate holes, or sets of elongate holes, are arranged in parallel to one another, in use the monitoring system may be arranged such that different pressures are provided in different elongate holes/sets of elongate holes. For example, elongate holes within a component can be arranged to be alternately connected to ambient pressure and a relative negative pressure.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

1-36. (canceled)

37. A method of monitoring for cracking of a component, the method comprising:
forming a component with a simultaneously formed elongate hole that is internal to the component;
attaching a connector having a throughway to the component, such that the throughway is in fluid communication with the elongate hole;
connecting the elongate hole to a pressure measurement instrument via the connector; and
monitoring the elongate hole for change in pressure level.

38. The method according to claim 37 further comprising:
providing a raw material; and wherein forming the component comprises
forming the component from the raw material and simultaneously introducing an elongate hole into the component that is internal to the component

39. The method as claimed in claim 37, wherein the forming step involves extruding the component and simultaneously extruding the elongate hole.

40. The method as claimed in claim 37, wherein the forming step involves inserting a core into a casting mould, casting the component and subsequently removing or burning out the core to form the elongate hole.

41. The method as claimed in claim 37, wherein the component is a laminate of a plurality of layers, and the forming step involves providing a elongate hole shape within the laminate during the lamination process.

42. The method as claimed in claim 37, wherein the elongate hole shape is provided by inserting a hole form between the two adjacent layers during the lamination process.

43. The method as claimed in claim 42, wherein the hole form is a tube.

44. The method as claimed in claim 42, wherein the hole form is a mandrel that is removed subsequent to the lamination process.

45. The method as claimed in claim 37, wherein the component is formed such that the elongate hole has an opening at a first surface of the component and the connector is attached to the elongate hole at the opening.

46. The method as claimed in claim 45, wherein the connector comprises a flange portion that is attached to the component adjacent the elongate hole and a tube portion extending from the flange portion, and wherein the throughway extends through the tube portion and the flange portion.

47. The method as claimed in claim 45, wherein the component has an internal thread provided within a portion of the elongate hole that is adjacent the opening, and the connector comprises an externally threaded portion that is received within the elongate hole and a tube portion extending from the threaded portion, the throughway extending through both the tube portion and the threaded portion.

48. The method as claimed in claim 47, wherein the connector further comprises a body portion disposed between the tube portion and threaded portion, the body portion having a larger outer diameter than both the tube portion and threaded portion.

49. The method as claimed in claim 37, wherein the elongate hole is one of a plurality of like elongate holes, each elongate hole being connected to one of the pressure measurement instrument and another of the like elongate holes.

50. The method as claimed in claim 45, wherein the component is formed such that the elongate hole has an opening at a second surface of the component, the method further comprising a step of sealing the elongate hole at or in a region adjacent the opening at the second surface.

51. The method as claimed in claim 50, wherein the sealing step comprises applying a sealant to fill a portion of the elongate hole adjacent the opening at the second surface.

52. The method as claimed in claim 50, wherein the sealing step comprises forming a secondary hole that extends transversely to the elongate hole such that the elongate hole and the secondary hole intercept, and inserting a plug into the secondary hole such that the elongate hole is sealed.

53. The method as claimed in claim 37, wherein the component further comprises a secondary hole that extends transversely to the elongate hole such that the elongate hole and the secondary hole intercept, and wherein the attaching step involves inserting the connector into the secondary hole.

54. The method as claimed in claim 53, wherein the connector comprises a pin portion through which the throughway extends, and the attaching step further involves inserting the pin portion into the secondary hole.

55. The method as claimed in claim 54, wherein the connector further comprises a head portion from which the pin portion extends, the head portion having an opening in fluid communication with the throughway, and wherein the connecting step involves inserting tubing into the opening.

56. The method as claimed in claim 54, wherein the throughway is one of a pair of like throughways in the connector, and the pin portion further comprises a partition for dividing the elongate hole into a first elongate hole and a second elongate hole.

57. The method as claimed in claim 56, wherein the partition provides a seal such that the first elongate hole is substantially in fluid isolation from the second elongate hole.

58. The method as claimed in claim 56, further comprising the step of aligning the pin portion within the secondary hole such that each of the throughways is in fluid communication with a respective one of the first or second elongate holes.

59. The method according to claim 37 comprising forming a plurality of the elongate holes, connecting one or more but not all of the said elongate holes to the pressure measurement system thereby leaving one or more unconnected elongate holes and in the event of a connected elongate hole becoming inoperable, disconnecting or isolating that hole and connecting at least one of the unconnected holes to the pressure measurement system.
